(19) United States
(12) Patent Application Publication
(10) Pub. No.: US 2013/0068016 A1
(43) Pub. Date: Mar. 21, 2013

(54) APPARATUS AND METHOD FOR IDENTIFYING MOTION OF OBJECT

(71) Applicants: Chung-Yuan Chen, Hsinchu County 302 (TW); Yu-Cheng Chang, Hsinchu County 302 (TW)

(72) Inventors: Chung-Yuan Chen, Hsinchu County 302 (TW); Yu-Cheng Chang, Hsinchu County 302 (TW)

(73) Assignee: SITRONIX TECHNOLOGY CORP., HSINCHU COUNTY 302 (TW)

(21) Appl. No.: 13/700,782

(22) PCT Filed: Jun. 14, 2011
(86) PCT No.: PCT/CN11/00985

§ 371 Date: Nov. 29, 2012

Related U.S. Application Data
(60) Provisional application No. 61/354,363, filed on Jun. 14, 2010.

(51) Int. Cl. G06F 3/03

(52) U.S. Cl. CPC G06F 3/03
USPC 73/488

(57) ABSTRACT

The present invention relates to an apparatus for identifying motions of an object, which is used for detecting motions of at least an object. A sensing plate senses the object and produces at least a sensing signal. A processing circuit is coupled to the sensing plate. It gives at least a moving speed along at least one axis, at least a variation in the sensed value between the object and the sensing plate, or at least a variation in the contact area according to the sensing signal. Then it produces a corresponding control signal according to the moving speed, the variation in the sensed value, or the variation in the contact area. Thereby, the present invention further produces a corresponding control signal by means of the variations in the sensed value. Hence, the control signal can be produced without touching the touch panel and thus increasing the lifetime of the touch panel.

### FIELD OF THE INVENTION

The present invention relates generally to a touch-controlled apparatus and a method thereof, and particularly to an apparatus and a method for identifying a motion of an object.

### BACKGROUND OF THE INVENTION

Modern technologies are developed prosperously. Various types of information products are provided unceasingly for satisfying people's different needs. Early displays are mainly cathode ray tube (CRT) displays. Owing to their huge size, high power consumption, and generated radiation, which are harmful for long-term users, current CRT displays in the market are gradually replaced by liquid crystal displays (LCDs). LCDs own the advantages of lightweight, small size, low radiation, and low power consumption. Thereby, they have become the mainstream in the market.

The manufacturing technologies of touch-controlled sensing apparatuses have constantly being improved in recent years. In addition, the performance and quality of products are greatly enhanced. Consequently, various types of touch-controlled sensing apparatuses are widely applied to electronic products, for example, mobile phones, digital cameras, personal digital assistants, electronic dictionaries, notebook computers, desktop computers, televisions, global positioning systems, automotive displays, aircraft displays, digital photo frames, or portable DVD players.

A general touch-controlled sensing apparatus is capacitive touch panel, which is an input device controlling movements of a pointer by sliding finger on a smooth plate. Because a capacitive touch panel is very thin, it can be designed in ultra-thin notebook computers, keyboards, digital players, or other apparatuses. Besides, thanks to its non-mechanical design, the maintenance of a capacitive touch panel is easy and simple.

FIG. 1 shows a cross-sectional view of a two-dimensional capacitive touch panel according to the prior art. As shown in the figure, the two-dimensional capacitive touch panel 100′ comprises a panel 102′, a Y-axis sensing layer 104′, an insulating layer 106′, an X-axis sensing layer 108′, and a bottom plate 110′. When a finger 112′ touches the panel 102′, the capacitance at the touched location changes. The control circuit connected to the touch panel 100′ can then convert the capacitance of the touch panel 100′ to a sensed value for judging the touch location, displacement, and moving direction of the finger 112′. According to the prior art, judging if an object (the finger 112′) touches the capacitive touch panel 100′ depends on the sensed value. When the sensing value is greater than a threshold value, it means that the object touches the touch panel 100′. On the contrary, when the sensed value is smaller than the threshold value, it means that the object leaves the touch panel 100′ or there is no any object 100′ on the touch panel 100′.

Nevertheless, the touch panel described above only identifies gestures in the two-dimensional space; it cannot do it in the three-dimensional space. Besides, the object needs to touch the touch panel for performing control, which tends to reduce the lifetime of the touch panel. Moreover, current LCD technologies are developed progressively, and thereby the applications utilizing three-dimensional gesture identification become increasingly important. Although three-dimensional gesture identification can be implemented using a touch panel along with imaging processing, the method needs greater hardware circuits and hence increasing costs. In addition, it consumes more power.

Accordingly, the present invention provides a novel touch-controlled apparatus and a method thereof, which use simple circuits to achieve three-dimensional gesture identification. In addition to increasing applications of a touch panel, the costs are saved and hence solving the problems described above.

### SUMMARY

An objective of the present invention is to provide an apparatus and a method for identifying motions of an object. The present invention produces a corresponding control signal by means of the moving speed, the energy variations, or the variations in the contact area for achieving the purpose of three-dimensional identification of the motions of the object.

Another objective of the present invention is to provide an apparatus and a method for identifying motions of an object. The present invention produces a corresponding control signal by means of the energy variations. Thereby, the control signal can be produced without touching the panel, and hence increasing the lifetime of the touch panel.

The apparatus for identifying motions of an object according to the present invention comprises a sensing plate and a processing circuit. The method for identifying is used for detecting motions of at least an object. The sensing plate senses the object and produces at least a sensing signal. The processing circuit is coupled to the sensing plate. It gives at least a moving speed along at least one axis, at least an energy variation between the object and the sensing plate, or at least a variation in the contact area according to the sensing signal. Then it produces a corresponding control signal according to the moving speed, the energy variation, or the variation in the contact area. Thereby, the present invention produces a corresponding control signal by means of the moving speed, the energy variations, or the variations in the contact area for achieving the purpose of three-dimensional identification of the motions of the object. Besides, the present invention further produces a corresponding control signal by means of the variations in the sensed value. Hence, the control signal can be produced without touching the touch panel and thus increasing the lifetime of the touch panel.

### BRIEF DESCRIPTION OF THE DRAWINGS

FIG. 1 shows a cross-sectional view of a two-dimensional capacitive touch panel according to the prior art;

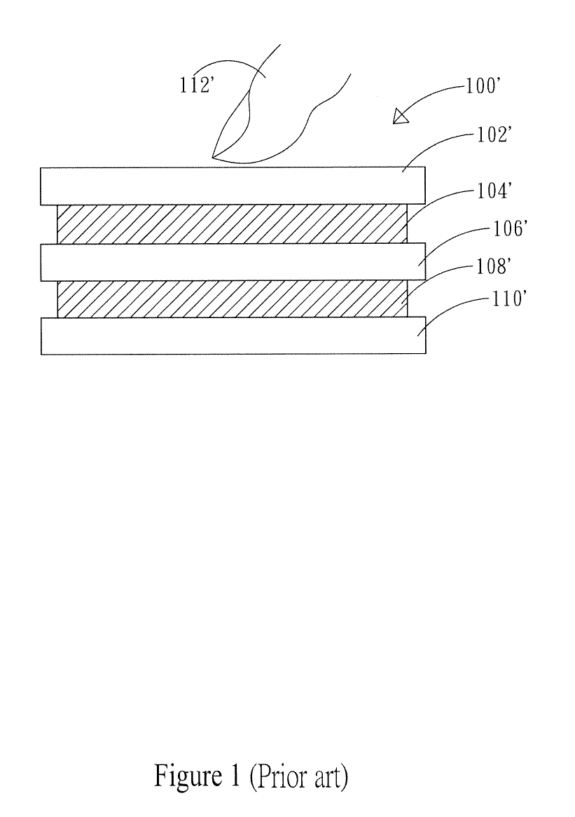

FIG. 2 shows a block diagram of an identifying apparatus according to an embodiment of the present invention;

FIG. 3A shows a schematic diagram of a sensing plate detecting an object according to an embodiment of the present invention; and

FIG. 3B shows a schematic diagram of a sensing plate detecting an object according to another embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

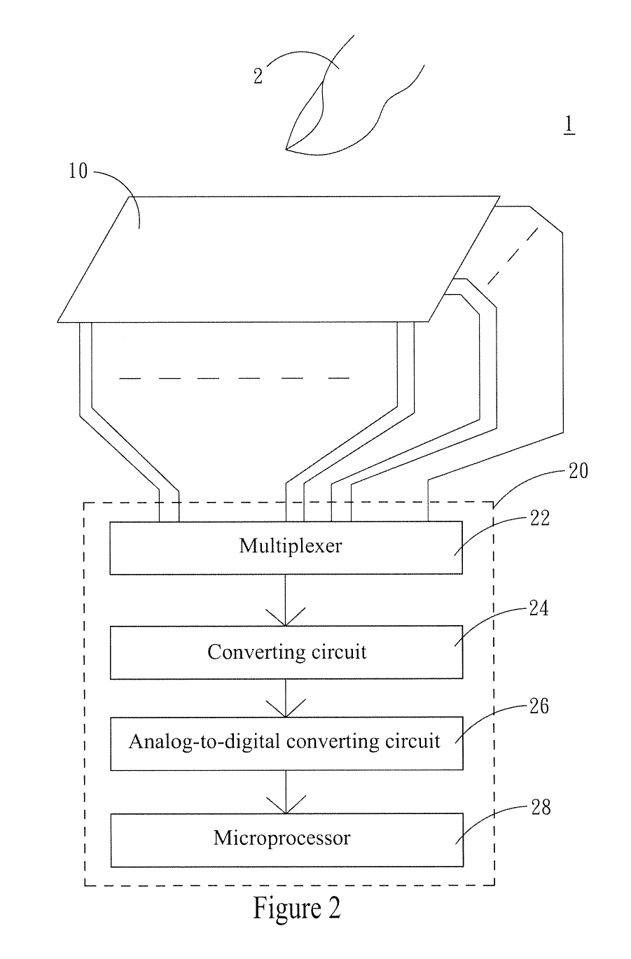

FIG. 2 shows a block diagram of an identifying apparatus according to an embodiment of the present invention. As shown in the figure, the apparatus for identifying motions of an object 1 according to the present invention is used for detecting and identifying motions of an object 2 and producing a control signal correspondingly for controlling subsequent circuits to execute corresponding actions. The object 2 can be a finger or a touch-controlled stylus. The apparatus for identifying 1 according to the present invention comprises a sensing plate 10 and a processing circuit 20. The sensing plate 10 is used for sensing the object 2 and producing at least a sensing signal. The processing circuit 20 is coupled to the sensing plate 10 and gives at least a moving speed of the object 2 along at least one axis. The processing circuit 20 further produces a corresponding control signal according to the moving speed. According to the control signal, the subsequent circuits can execute corresponding actions.

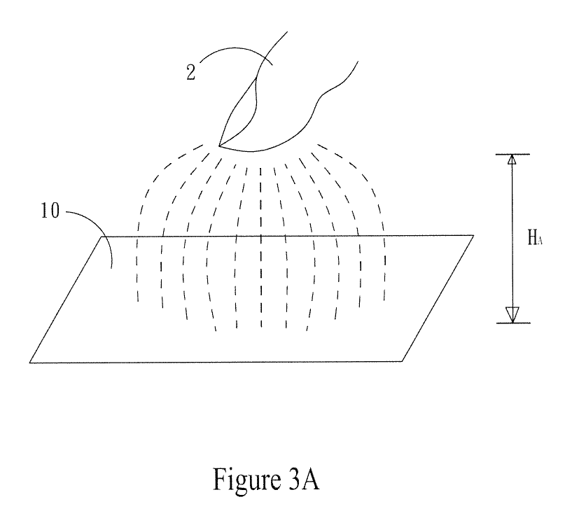

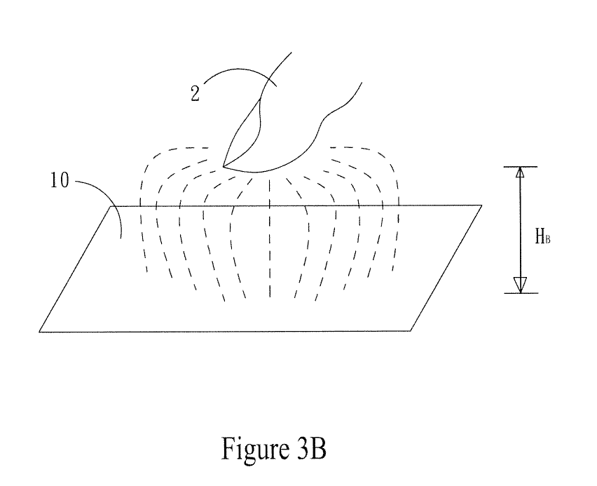

FIGS. 3A and 3B show schematic diagrams of the sensing plate detecting the object according to an embodiment of the present invention. As shown in the figures, the sensing plate 10 has a plurality of scan lines and a plurality of detecting lines. The sensing plate 10 receives a supply voltage by means of the plurality of scan lines for detecting the motions of the object 2 and producing the sensing signal. After the sensing plate 10 receives the supply voltage, as the object 2 approaches the sensing plate to a certain height H_{A}, a displacement current I_{D}, which is the sensing signal, is produced correspondingly. The processing circuit 20 then knows the energy between the object 2 and the sensing plate 10 according to the displace current I_{D}. In the present embodiment, when the processing circuit 20 receives the displacement current I_{D}, it is known that:

$${I}_{D} = ɛ \frac{d {Φ}_{E}}{d t} \qquad ( 1 )$$

The displacement current I_{D} is related to the energy, which is the magnetic induction Φ_{E}, between the object 2 and the sensing plate 10. Thereby, according to the displacement current I_{D}, the processing circuit 20 according to the present invention can know the energy, namely, the magnetic induction Φ_{E}, which, in turn, gives the height between the object 2 and the sensing plate 10, such as the first height H_{A} in FIG. 3A and the second height H_{B} in FIG. 3B. Consequently, when the processing circuit 20 can give the first height H_{A} and the second height H_{B} between the object 2 and the sensing plate 10 within a time interval, the moving speed can be calculated. In addition, a corresponding control signal can be produced according to the moving speed for the subsequent circuits, which can have corresponding actions according to the control signal. In other words, the processing circuit 20 compares the moving speed with a reference value for producing the control signal correspondingly. When the moving speed is greater than the reference value, the corresponding control signal is produced for the subsequent circuits for a corresponding action; when the moving speed is smaller than the reference value, another corresponding control signal is produced for the subsequent circuits for another corresponding action. For example, when the moving speed is greater than the reference value, namely, the object 2 approaches or leaves the sensing plate 10 rapidly, the control signal is produced for the subsequent circuits for controlling the electronic device to increase its volume; when the moving speed is smaller than the reference value, namely, the object 2 approaches or leaves the sensing plate 10 slowly, the control signal is produced for the subsequent circuits for controlling the electronic device to reduce its volume. The above embodiment is only an example of the present invention. The present invention is not limited to controlling the volume of an electronic device.

Moreover, in addition to producing the corresponding control signals by purely judging the moving speed at which the object 2 approaches or leaves the sensing plate 10, the processing circuit 20 can further use the moving speed at which the object 2 approaches or leaves the sensing plate 10 to produce control signal correspondingly. That is to say, the processing circuit produces a first moving speed in a first time interval according to the sensing signal (namely, the displacement current I_{D} produced when the object 2 approaches the sensing plate 10); it also produces a second moving speed in a second time interval according to the sensing signal (namely, the displacement current I_{D} produced when the object 2 leaves the sensing plate 10). The processing circuit 20 compares the first moving speed with a first threshold value and the second moving speed with a second threshold value for producing a corresponding control signal. In other words, when the processing circuit 20 compares and judges that the first moving speed is greater than the first threshold value and the second moving speed is greater than the second threshold value, it produces a first control signal. Likewise, when the processing circuit 20 compares and judges that the first moving speed is greater than the first threshold value and the second moving speed is smaller than the second threshold value, it produces a second control signal; when the processing circuit 20 compares and judges that the first moving speed is smaller than the first threshold value and the second moving speed is smaller than the second threshold value, it produces a third control signal; and when the processing circuit 20 compares and judges that the first moving speed is smaller than the first threshold value and the second moving speed is greater than the second threshold value, it produces a fourth control signal. Thereby, the processing circuit 20 produces the first to the fourth control signals for controlling the subsequent circuits to execute different actions correspondingly according to the first to the fourth control signals. Consequently, by computing the moving speed between the object 2 and the sensing plate 10, the purpose of three-dimensional identification of objects is achieved.

In addition to calculating the moving speed according to the equation (1), it is known from the equation (2) below:

Φ_{E}=\vec{E}·\vec{A} (2)

The magnetic induction Φ_{E} corresponds to the electric field \vec{E} and the area \vec{A} between the object 2 and the sensing plate 10. Thereby, the processing circuit 20 can also use the energy, such as the electric field \vec{E}, between the object 2 and the sensing plate 10 to produce the corresponding control signal for controlling the subsequent circuits. Consequently, the control signal can be produced without touching the panel, and hence increasing lifetime of touch panels.

Accordingly, the processing circuit can produce a first energy in a first time interval according to the sensing signal (namely, the displacement current I_{D}); it also produces a second energy in a second time interval according to the sensing signal (namely, the displacement current I_{D}). Afterwards, the processing circuit 20 compares the first energy with a first threshold value and the second energy with a second threshold value for producing a corresponding control signal. In other words, when the processing circuit 20 compares and judges that the first energy is greater than the first threshold value and the second energy is greater than the second threshold value, it produces a first control signal; when the processing circuit 20 compares and judges that the first energy is greater than the first threshold value and the second energy is smaller than the second threshold value, it produces a second control signal; when the processing circuit 20 compares and judges that the first energy is smaller than the first threshold value and the second energy is smaller than the second threshold value, it produces a third control signal; and when the processing circuit 20 compares and judges that the first energy is smaller than the first threshold value and the second energy is greater than the second threshold value, it produces a fourth control signal. Thereby, the processing circuit 20 produces the first to the fourth control signals for controlling the subsequent circuits to execute different actions correspondingly according to the first to the fourth control signals.

Furthermore, when the object 2, which is a finger in the present embodiment, contacts the sensing plate 10, according to the equation (2), it is known that the magnetic induction corresponds to the area \vec{A} between the object 2 and the sensing plate 10. That is to say, when the object 2 contacts the sensing plate 10, a contact area between the object 2 and the sensing plate 10 changes. When the object 2 touches the sensing plate 10, the contact area increases gradually; when the object 2 moves away form the sensing plate 10, the contact area reduces gradually. Thereby, the processing circuit knows the variation of at least a contact area of the object 2 according to the sensing signal (namely, the displacement current I_{D}), and produces the corresponding control signal according to the variation of the contact area. The processing circuit can produce a first contact area in a first time interval according to the sensing signal (namely, the displacement current I_{D}); it also produces a second contact area in a second time interval according to the sensing signal (namely, the displacement current I_{D}). Afterwards, the processing circuit 20 compares the first contact area with a first threshold value and the second contact area with a second threshold value for producing a corresponding control signal. In other words, when the processing circuit 20 compares and judges that the first contact area is greater than the first threshold value and the second contact area is greater than the second threshold value, it produces a first control signal; when the processing circuit 20 compares and judges that the first contact area is greater than the first threshold value and the second contact area is smaller than the second threshold value, it produces a second control signal; when the processing circuit 20 compares and judges that the first contact area is smaller than the first threshold value and the second contact area is smaller than the second threshold value, it produces a third control signal; and when the processing circuit 20 compares and judges that the first contact area is smaller than the first threshold value and the second contact area is greater than the second threshold value, it produces a fourth control signal. Thereby, the processing circuit 20 produces the first to the fourth control signals for controlling the subsequent circuits to execute different actions correspondingly according to the first to the fourth control signals.

Referring to FIG. 2, the processing circuit 20 according to the present invention comprises a multiplexer 22, a converting circuit 24, an analog-to-digital converting circuit 26, and a microprocessor 28. The multiplexer 22 is coupled to the plurality of scan lines and the plurality of detecting lines of the sensing plate 10 for transmitting the sensing signal. The converting circuit 24 is coupled to the multiplexer 22, and receives and converting the sensing signal for producing a converting signal. The analog-to-digital converting circuit 26 is coupled to the converting circuit 24 and converts the converting signal to produce a digital signal. The microprocessor 28 is coupled to the analog-to-digital converting circuit 26. According to the sensing signal, the microprocessor 28 knows the moving speed, the energy variation, or the contact area variation of the object 2 along at least one axis, and produces the corresponding control signal according to the moving speed, the energy variation, or the contact area variation.

To sum up, the apparatus for identifying motions of an object according to the present invention is used for detecting motions of at least an object. A sensing plate senses the object and produces at least a sensing signal. A processing circuit is coupled to the sensing plate. It gives at least a moving speed along at least one axis, at least a variation in the sensed value between the object and the sensing plate, or at least a variation in the contact area according to the sensing signal. Then it produces a corresponding control signal according to the moving speed, the variation in the sensed value, or the variation in the contact area. Thereby, the present invention further produces a corresponding control signal by means of the variations in the sensed value. Hence, the control signal can be produced without touching the touch panel and thus increasing the lifetime of the touch panel.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An apparatus for identifying motions of an object, used for detecting motions of at least an object, comprising:
a sensing plate, sensing said object and producing at least a sensing signal; and
a processing circuit, coupled to said sensing plate, giving at least a moving speed of said object along at least one axis or at least a variation in the energy between said object and said sensing plate or at least a variation in the contact area between said object and said sensing plate, and producing a corresponding control signal according to said moving speed, said variation in the energy, or said variation in the contact area.

2. The apparatus for identifying motions of an object of claim 1, wherein said processing circuit produces a first moving speed, a first variation in the energy, or a first variation in the contact area in a first time interval according to said sensing signal, produces a second moving speed, a second variation in the energy, or a second variation in the contact area in a second time interval according to said sensing signal, compares said first moving speed, said first variation in the energy, or said first variation in the contact area with a first threshold value, and compares said second moving speed, said second variation in the energy, or said second variation in the contact area with a second threshold value for producing said control signal.

3. The apparatus for identifying motions of an object of claim 2, wherein said processing circuit compares and judges that said first moving speed, said first variation in the energy, or said first variation in the contact area is greater than said first threshold value, compares and judges that said second moving speed, said second variation in the energy, or said second variation in the contact area is greater than said second threshold value, and then produces said control signal correspondingly.

4. The apparatus for identifying motions of an object of claim 1, wherein said processing circuit comprises:
a multiplexer, coupled to a plurality of scan lines and a plurality of detecting lines of said sensing plate for transmitting said sensing signal;
a converting circuit, coupled to said multiplexer, and receiving and converting said sensing signal for producing a converting signal;
an analog-to-digital converting circuit, coupled to said converting circuit, and converting said converting signal for producing a digital signal; and
a microprocessor, coupled to said analog-to-digital converting circuit, giving said moving speed along at least one axis or said variation in the energy or said variation in the contact area of said object according to said sensing signal, and producing said corresponding control signal according to said moving speed or said variation in the energy or said variation in the contact area.

5. A method for identifying motions of an object, used for detecting motions of at least an object, comprising steps of:
sensing said object and producing at least a sensing signal;
giving at least a moving speed of said object along at least one axis according to said sensing signal; and
producing a corresponding control signal according to said moving speed.

6. The method for identifying motions of an object of claim 5, wherein said step of producing said corresponding control signal according to said moving speed further comprises steps of:
producing a first moving speed in a first time interval and a second moving speed in a second time interval according to said sensing signal; and
comparing said first moving speed with a first threshold value and said second moving speed with a second threshold value for producing said control signal correspondingly.

7. The method for identifying motions of an object of claim 6, wherein said control signal is produced correspondingly when said first moving speed is greater than said first threshold value and said second moving speed is greater than said second threshold value.

8. A method for identifying motions of an object, used for detecting motions of at least an object, comprising steps of:
sensing said object and a sensing plate and producing at least a sensing signal;
giving at least a variation in the energy between said object and said sensing plate according to said sensing signal; and
producing a corresponding control signal according to said variation in the energy.

9. The method for identifying motions of an object of claim 8, wherein said step of producing said corresponding control signal according to said variation in the energy further comprises steps of:
producing a first variation in the energy in a first time interval and a second variation in the energy in a second time interval according to said sensing signal; and
comparing said first variation in the energy with a first threshold value and said second variation in the energy with a second threshold value for producing said control signal correspondingly.

10. The method for identifying motions of an object of claim 9, wherein said control signal is produced correspondingly when said first variation in the energy is greater than said first threshold value and said second variation in the energy is greater than said second threshold value.

11. A method for identifying motions of an object, used for detecting motions of at least an object, comprising steps of:
sensing said object contacting a sensing plate and producing at least a sensing signal;
giving at least a variation in the contact area between said object and said sensing plate according to said sensing signal; and
producing a corresponding control signal according to said variation in the contact area.

12. The method for identifying motions of an object of claim 11, wherein said step of producing said corresponding control signal according to said variation in the contact area further comprises steps of:
producing a first variation in the contact area in a first time interval and a second variation in the contact area in a second time interval according to said sensing signal; and
comparing said first variation in the contact area with a first threshold value and said second variation in the contact area with a second threshold value for producing said control signal correspondingly.

13. The method for identifying motions of an object of claim 12, wherein said control signal is produced correspondingly when said first variation in the contact area is greater than said first threshold value and said second variation in the contact area is greater than said second threshold value.
